(19) United States
(12) Patent Application Publication
(10) Pub. No.: US 2014/0370745 A1
(43) Pub. Date: Dec. 18, 2014

(54) CONNECTOR BRACKET

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventor: LIN-HAN WU, Shenzhen (CN)

(73) Assignees: HONG FU JIN PRECISION INDUSTRY (ShenZhen) CO., LTD., Shenzhen (CN); HON HAI PRECISION INDUSTRY CO., LTD., New Taipei (TW)

(21) Appl. No.: 14/221,240

(22) Filed: Mar. 20, 2014

(30) Foreign Application Priority Data
Jun. 17, 2013 (CN) 2013102383808

(51) Int. Cl. H01R 13/516

(52) U.S. Cl. CPC H01R 13/516
USPC 439/527

(57) ABSTRACT

A connector bracket includes a mounting portion and a fixing portion integral with the mounting portion. The mounting portion may receive and mount a connector. The fixing portion may be fixed to a housing of an electronic device. Thus, the connector bracket and the connector are fixed to the housing of the electronic device.

### REFERENCE TO RELATED APPLICATIONS

This application claims all benefits accruing under 35 U.S.C. §119 from China Patent Application No. 201310238380.8 filed on Jun. 17, 2013 in the State Intellectual Property Office of China, the contents of the China Application are hereby incorporated by reference.

### BACKGROUND

1. Technical Field

The present disclosure generally relates to mounting apparatuses, and particularly relates to connector brackets for mounting a connector.

2. Description of Related Art

Connectors are commonly used to interconnect electronic components in computers. As a result of the rapid development of the computer technology, a modern computer often includes a mass of electronic components and connectors enclosed in a relative small chassis. Because of the limited space inside the chassis, these electronic components and the connectors are often intertwined with each other, resulting in a disjointed layout and excess electromagnetic interference.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of a connector bracket and a connector.

FIG. 2 is similar to FIG. 1, but viewed from another aspect.

FIG. 3 is an assembled view of the connector bracket and the connector of FIG. 1.

FIG. 4 is similar to FIG. 3, but viewed from another aspect.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

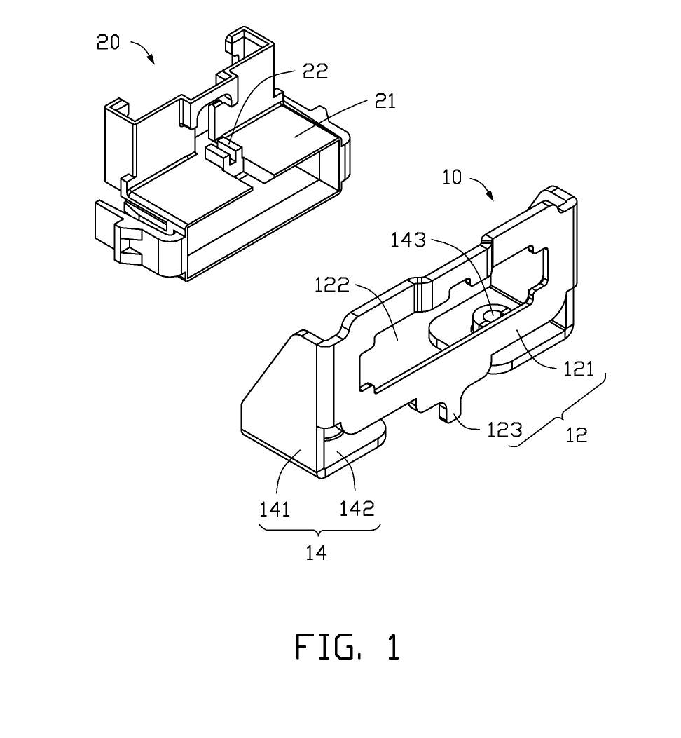

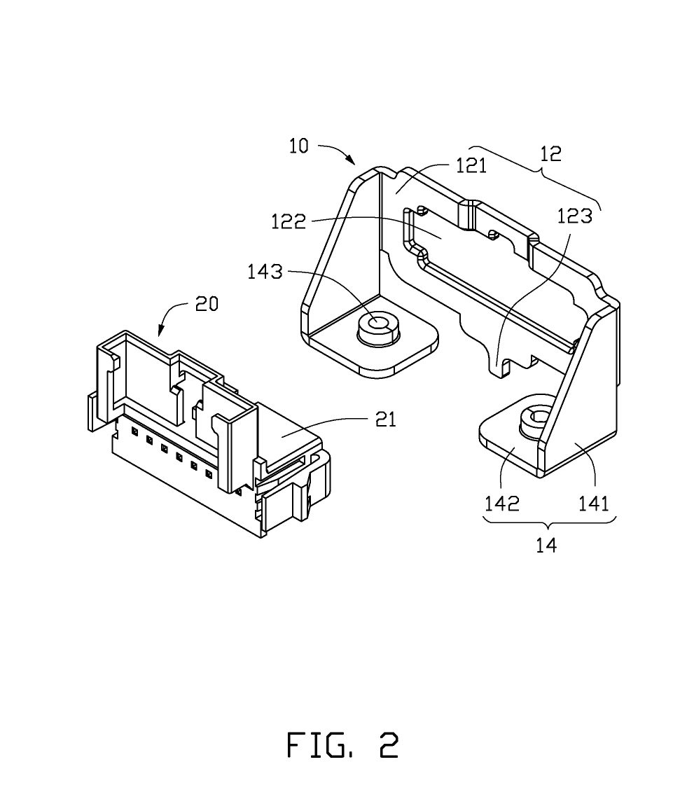

FIGS. 1 and 2 show an embodiment of a connector bracket 10. The connector bracket 10 includes a mounting portion 12 for mounting a connector 20 and a fixing portion 14 integral with the mounting portion 12. The fixing portion 14 may be fixed to a housing of an electronic device, such as a computer, so that the connector bracket 10 and the connector 20 are fixed to the electronic device.

The mounting portion 12 includes a mounting plate 121. The mounting plate 121 defines a mounting hole 122 for receiving the connector 20.

The fixing portion 14 includes a connecting plate 141 and a fixing plate 142. The connecting plate 141 extends from a side edge of the mounting plate 121. The fixing plate 142 extends from a bottom edge of the connecting plate 141. The fixing plate 142 defines a fixing hole 143. The connecting plate 141 is substantially perpendicular to the mounting plate 121. The fixing plate 142 is substantially perpendicular to the connecting plate 141.

The connector 20 includes a main body 21 and a latching portion 22. The latching portion 22 protrudes from an outer surface of the main body 21. In one embodiment, a cross section of the latching portion 22 is substantially U-shaped.

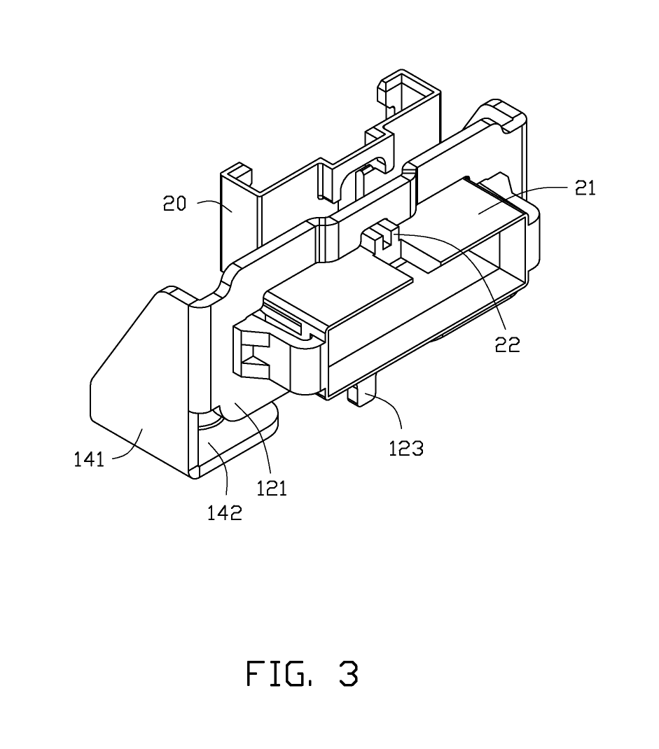

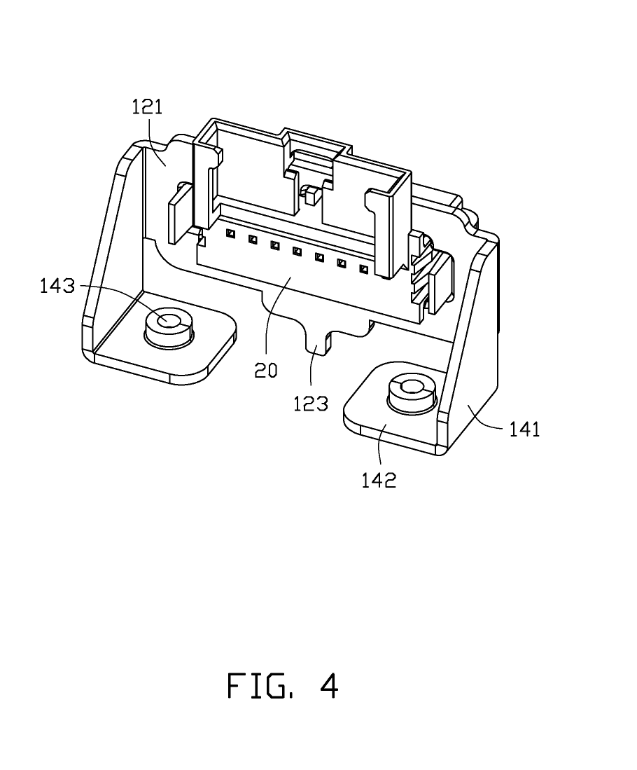

FIGS. 3-4 show that in assembly, the fixing hole 143 of the connector bracket 10 is aligned with a corresponding hole of a housing of an electronic device (not shown). A fixing member, such as a screw, is inserted into both the fixing hole 143 and the corresponding hole thereby fixing the connector bracket 10 to the housing of the electronic device. The main body 21 of the connector 20 is inserted into the mounting hole 122 of the connector bracket 10 until the latching portion 22 of the connector 20 is engaged with the mounting hole 122. Thus, the connector 20 is mounted to the connector bracket 10 and thereby is fixed to the housing of the electronic device.

In another embodiment, the mounting portion 12 of the connector bracket 10 further includes a plug portion 123. The plug portion 123 extends downward from a bottom edge of the mounting plate 121. The plug portion 123 and the mounting plate 121 are substantially on the same plane. In assembly, the plug portion 123 of the connector bracket 10 is inserted into a positioning hole (not shown) of the housing of the electronic device thereby facilitating the fixation of the connector bracket 10 to the housing of the electronic device.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A connector bracket, comprising:
a mounting portion for mounting a connector; and
a fixing portion integral with the mounting portion, the fixing portion for being fixed to a housing of an electronic device thereby fixing the connector bracket and the connector to the housing of the electronic device.

2. The connector bracket of claim 1, wherein the mounting portion comprises a mounting plate, and the mounting plate defines a mounting hole for receiving the connector.

3. The connector bracket of claim 2, wherein the fixing portion defines a fixing hole aligned with a corresponding hole of the housing of the electronic device, a fixing member is inserted into the fixing hole and the corresponding hole thereby fixing the connector bracket to the housing of the electronic device.

4. The connector bracket of claim 3, wherein the fixing portion comprises a connecting plate extending from a side edge of the mounting plate and a fixing plate extending from a bottom edge of the connecting plate, and the fixing plate defines the fixing hole.

5. The connector bracket of claim 4, wherein the connecting plate is substantially perpendicular to the mounting plate.

6. The connector bracket of claim 4, wherein the fixing plate is substantially perpendicular to the connecting plate.

7. The connector bracket of claim 4, further comprising a plug portion inserted into a positioning hole of the housing of the electronic device thereby facilitating the fixation of the connector bracket to the housing of the electronic device.

8. The connector bracket of claim 7, wherein the plug portion extends downward from a bottom edge of the mounting plate.

9. The connector bracket of claim 8, wherein the plug portion and the mounting plate are substantially on the same plane.

10. A connector assembly, comprising:
a connector,
a mounting portion for mounting the connector; and
a fixing portion integral with the mounting portion, the fixing portion for being fixed to a housing of an electronic device thereby fixing the connector bracket and the connector to the housing of the electronic device.

11. The connector assembly of claim 10, wherein the mounting portion comprises a mounting plate, and the mounting plate defines a mounting hole for receiving the connector.

12. The connector assembly of claim 11, wherein the fixing portion defines a fixing hole aligned with a corresponding hole of the housing of the electronic device, a fixing member is inserted into the fixing hole and the corresponding hole thereby fixing the connector bracket to the housing of the electronic device.

13. The connector assembly of claim 12, wherein the fixing portion comprises a connecting plate extending from a side edge of the mounting plate and a fixing plate extending from a bottom edge of the connecting plate, and the fixing plate defines the fixing hole.

14. The connector assembly of claim 13, wherein the connecting plate is substantially perpendicular to the mounting plate.

15. The connector assembly of claim 13, wherein the fixing plate is substantially perpendicular to the connecting plate.

16. The connector assembly of claim 13, wherein the connector bracket further comprises a plug portion inserted into a positioning hole of the housing of the electronic device thereby facilitating fixation of the connector bracket to the housing of the electronic device.

17. The connector assembly of claim 16, wherein the plug portion extends downward from a bottom edge of the mounting plate.

18. The connector assembly of claim 17, wherein the connector comprises a latching portion engaged with the mounting hole of the connector bracket thereby mounting the connector to the connector bracket.

19. The connector assembly of claim 18, wherein the connector comprises a main body and the latching portion protrudes from an outer surface of the main body.

20. The connector assembly of claim 19, wherein a cross section of the latching portion is substantially U-shaped.
